(19) United States
(12) Patent Application Publication
(10) Pub. No.: US 2015/0110456 A1
(43) Pub. Date: Apr. 23, 2015

(54) SYSTEM FOR PROVIDING VIDEO FOR VISUALLY IMPAIRED PERSON

(71) Applicant: HIMS International Corp., Daejeon (KR)

(72) Inventors: Yang Taik YOON, Daejeon (KR); Kyeong Seon CHOI, Daejeon (KR); Sang Jun LEE, Daejeon (KR); Il Hyung KIM, Daejeon (KR); Young Guk RYU, Daejeon (KR)

(73) Assignee: HIMS International Corp., Daejeon (KR)

(21) Appl. No.: 14/263,020

(22) Filed: Apr. 28, 2014

(30) Foreign Application Priority Data
Oct. 18, 2013 (KR) 10-2013-0124305

(51) Int. Cl. H04N 5/262; G11B 27/10; G11B 20/10; H04N 5/77; G11B 20/00

(52) U.S. Cl. CPC H04N 5/2628; H04N 5/77; G11B 20/00007; G11B 20/10527; G11B 27/10; G11B 2020/00072
USPC 386/201; 386/224

(57) ABSTRACT

Disclosed is a system for providing video for a visually impaired person. The system captures video of a subject to be captured using a video capturing unit, compresses the captured video, and employs wireless data transmission for transmitting the compressed video over a wireless communication network in real time. The system includes a video capturing unit for capturing video of a subject, and a video output unit for controlling the video capturing unit and displaying the video captured by the video capturing unit.

### BACKGROUND OF THE INVENTION

1. Field of the Invention

The present invention relates, in general, to a system for providing video for a visually impaired person, and, more particularly, to a system for providing video for a visually impaired person, which capturing video of a short- or long-distance subject to be captured using a video capturing unit, and compressing the captured video, and employs wireless data transmission for transmitting the compressed video over a wireless communication network in real time.

2. Description of the Related Art

Generally, visually impaired persons are deprived of their normal vision due to various eye diseases, and have difficulty recognizing objects, if even possible, or can only recognize objects within a very short distance. Image enlarging devices are used to compensate for visually impaired persons. Image enlarging devices enlarge and show images of objects such as books, medicine bottles, receipts, etc. that are encountered in daily life. Such image enlarging devices are connected to image output devices such as televisions or monitors by cables, and output captured images.

In this regard, a real image system disclosed in Korean Unexamined Patent Application Publication No. 10-1997-0073059 (hereinafter referred to as “patent document 1”) includes: an image capturing means on which a subject is put and which is configured to capture an image from the subject, to convert the captured optical image into a video signal, and to output the video signal; an image enlarging means that is removably mounted on the image capturing means, enlarges the image of the subject with a high magnification, and transmits the enlarged image to the image capturing means; and an image outputting means that receives the video signal output from the image capturing means, converts the video signal into the image, and outputs the image.

In patent document 1, the subject is enlarged and captured with a high magnification, and thereby the enlarged image can be provided for a visually impaired person. However, patent document 1 provides the captured image to the image outputting means using a cable. Since the image capturing means and the image outputting means are connected by a cable, there is an inconvenience that the cable should be connected. To connect the two means using the cable, a visually impaired person who has difficulty recognizing an object has to search for the cable corresponding to each port of the means, and may have difficulty connecting the cable to each port.

Further, the installing means are subjected to spatial restrictions due to a length of the cable when used.

In addition, there is a limitation that one image outputting means can be connected to one image capturing means.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) Korean Unexamined Patent Application Publication No. 10-1997-0073059 (published on Nov. 7, 1997, and entitled SYSTEM AND APPARATUS FOR REAL IMAGE)

### SUMMARY OF THE INVENTION

Accordingly, the present invention has been made keeping in mind the above problems occurring in the related art, and the present invention is intended to propose a system for providing video for a visually impaired person, capable of wirelessly providing video captured by a video capturing unit to an output unit.

The present invention is also intended to propose a system for providing video for a visually impaired person, capable of providing the video captured by a video capturing unit to a plurality of video output units by a wireless sharing function.

The present invention is also intended to propose a system for providing video for a visually impaired person, capable of controlling a video capturing unit to receive and output the video by radio using video output and control functions included in the video capturing unit.

In order to achieve the above object, according to an aspect of the present invention, a system for providing video for a visually impaired person includes: a video capturing unit configured to capture video of a subject; and a master output unit configured to control the video capturing unit and display the video captured by the video capturing unit. The video capturing unit includes: a video capturing means configured to have at least one camera device for capturing the video of the subject; an encoder configured to compress the video in a predetermined data format; a first communication part configured to transmit the compressed video data to the master output unit over a wireless communication network; and a controller configured to control the video capturing means, the encoder, and the first communication part. The master output unit includes: an input configured to input a control signal for controlling the video capturing unit; a second communication part configured to transmit the input control signal to the video capturing unit over the wireless communication network and to receive the processed video data from the video capturing unit; a first decoder configured to decode the video data received from the video capturing unit; a first display configured to output the decoded video data; and a storage configured to store the received video data.

Here, the first communication part may include a function as a wireless sharer, be set to a security mode, and transmit the video data to the master output unit that is granted access to the video capturing unit.

The system may further include a slave output unit having a third communication part receiving the processed video data from the video capturing unit, a second decoder decoding the video data received from the video capturing unit, and a second display outputting the decoded video data.

Further, the video capturing unit may further include a driving means for rotating the video capturing means.

In addition, the video capturing unit may further include a microphone receiving audio data from outside, and the storage may synchronize the video data and the audio data and store the synchronized data.

According to the video providing system of the present invention, the video captured by the video capturing unit is provided to the data output unit. Thereby, the video can be provided regardless of a distance. Further, the captured video can be easily provided to a plurality of output units by a wireless sharing function.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing a video providing system using wireless data transmission in accordance with the present invention;

FIG. 2 is a functional block diagram showing the video providing system in accordance with the present invention;

FIG. 3 is a flow chart showing first and second embodiments for a visually impaired person in accordance with the present invention;

FIG. 4 is a flow chart showing a third embodiment for a visually impaired person in accordance with the present invention;

FIG. 5 is a flow chart showing process A of the third embodiment for the visually impaired person in accordance with the present invention;

FIG. 6 is a flow chart showing a fourth embodiment for a visually impaired person in accordance with the present invention;

FIG. 7 is a flow chart showing process B of the fourth embodiment for the visually impaired person in accordance with the present invention; and

FIG. 8 is a conceptual view showing a driving means in accordance with the present invention.

### DETAILED DESCRIPTION OF THE INVENTION

Hereinbelow, exemplary embodiments of the present invention will be described in detail with reference to the accompanying drawings. In the following description of the present invention, a detailed description of known functions and configurations incorporated herein will be omitted when it may make the subject matter of the present invention unclear.

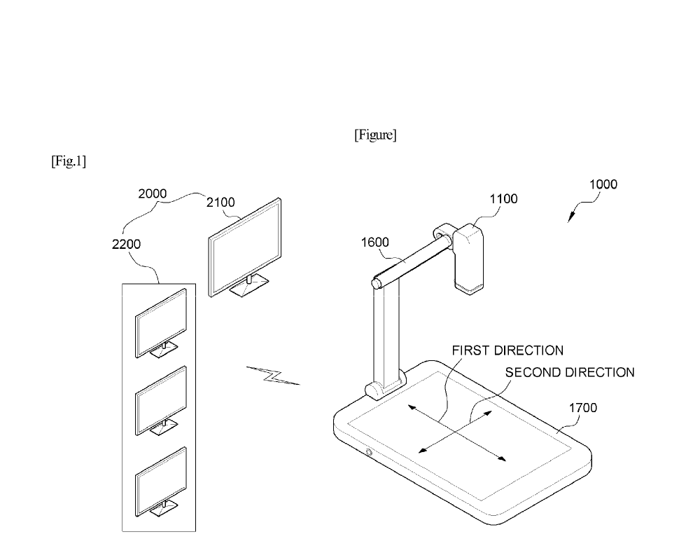

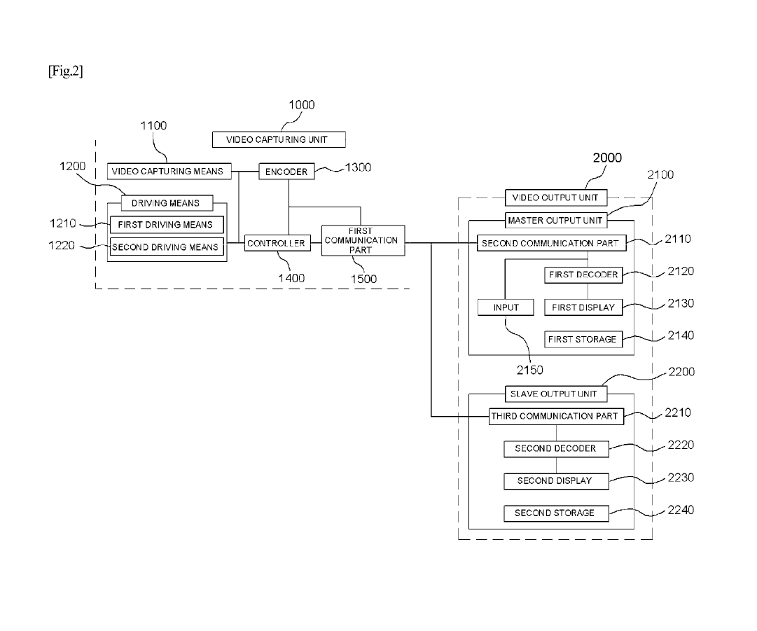

A system for providing an image for a visually impaired person according to an exemplary embodiment of the present invention will be described in detail with reference to the accompanying drawings. FIG. 1 is a perspective view showing a video providing system using wireless data transmission in accordance with the present invention. FIG. 2 is a conceptual view showing a video providing system in accordance with the present invention.

Referring to FIGS. 1 and 2, a video providing system of the present invention includes a video capturing unit 1000 and a video output unit 2000 for displaying video captured by the video capturing unit 1000 to a user.

Referring to FIG. 1 again, the video capturing unit 1000 includes a video capturing means 1100 having a device, such as a camera or a camcorder, capable of capturing a still image or a moving image, a support 1600 for supporting the video capturing means 1100, and a base 1700 for fixing the support 1600.

Referring to FIG. 2, the video capturing unit 1000 includes a video capturing means 1100, a driving means 1200 for increasing capturing efficiency of the video capturing means 1100, an encoder 1300 for processing captured video, a first communication part 1500 for transmitting the captured video to the video output unit 2000, and a controller 1400 for controlling these components. Meanwhile, the video capturing means 1100 may be provided with a microphone (not shown) for recording audio during video capturing.

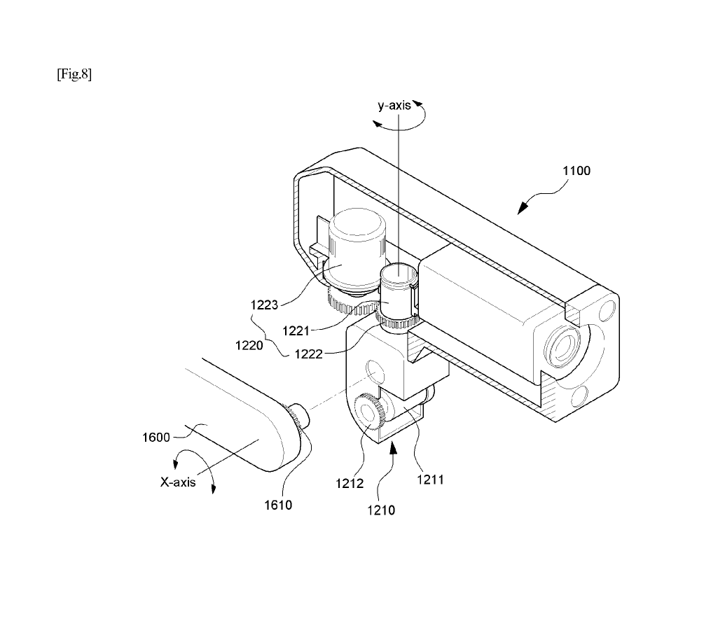

Referring to FIGS. 2 and 8, the driving means 1200 includes a first driving means 1210 for rotating the video capturing means 1100 in a first direction (see FIG. 1), and a second driving means 1220 for rotating the video capturing means 1100 in a second direction (see FIG. 1).

Referring to FIG. 2, the encoder 1300 compresses data of the video captured by the capturing means 1100 and data of the audio received from the microphone using a compression algorithm such as moving picture experts group (MPEG). When transmitted in real time, uncompressed video is transmitted with a high resolution. As such, an amount of data for transmitting the video is increased. Since the amount of the transmitted video data is increased, transmission delay may occur when the video is transmitted by radio. The video output unit 2000 receives and outputs the video received from the video capturing unit 1000 as delayed video rather than real-time video and as video whose frame rate is low. Thereby, such video comes short of usefulness and convenience from the standpoint of a user. Thus, the video to be transmitted is compressed into optimized video information by the encoder 1300. The compressed video gives an effect of reducing the amount of data. Due to the reduced amount of data, a wireless transceiving speed is increased. As a result, when the video captured by the video capturing unit 1000 is output by the video output unit 2000, this can be realized at the same frame rate as the video capturing unit 1000 in real time.

Referring to FIG. 2, the first communication part 1500 transmits the video data compressed by the encoder 1300 to second and third communication parts 2110 and 2210 and then first and second decoders 2120 and 2220 over a wireless communication network. The first and second decoders 2120 and 2220 decode the compressed video data, and transmit the decoded video data to the first and second displays 2130 and 2230, respectively. The first communication part 1500 of the video capturing unit 1000 uses a Wi-Fi wireless communication module so as to be able to perform short distance wireless or mobile communication with the second and third communication parts 2110 and 2210 of the video output unit 2000. A high quality of video can be transmitted by the Wi-Fi wireless communication module.

Referring to FIG. 2, the controller 1400 controls each of operations of the video capturing means 1100, the driving means 1200, the encoder 1300, and the first communication part 1500. Referring to FIG. 2, the video output unit 2000 may be divided into a master output unit 2100 and a slave output unit 2200. The master output unit 2100 does not only display the video captured by the video capturing means 1100 of the video capturing unit 1000 but also transmits an instruction to the controller 1400, thereby making it possible to control the video capturing unit 1000. The master output unit 2100 includes a second communication part 2110, a first decoder 2120, a display 2130, a storage 2140, and an input 2150. Meanwhile, the slave output unit 2200 may not have a function of the input 2150 of the master output unit 2100.

Referring to FIG. 2, the second communication part 2110 of the master output unit 2100 transmits a control signal input from the input 2150 (to be described below) to the video capturing unit 1000 over the wireless communication network. Further, the second communication part 2110 receives the video data and the audio data from the video capturing unit 1000 over the wireless communication network.

Referring to FIG. 2, the input 2150 of the master output unit 2100 is a means for inputting control signals for controlling the video capturing means 1100 and the driving means 1200. The input 2150 receives an instruction or data by means of a push or touch motion of a user. The input means includes a joy stick, a button, a touch panel, a mouse, a keyboard, or the like.

In the present invention, a touch panel capable of using both a display function and an input function is preferably used.

Referring to FIG. 2, the first display 2130 of the master output unit 2100 outputs the video data received from the video capturing unit 1000. The first display 2130 is a device capable of outputting video, and may employ a liquid crystal display (LCD) or a light-emitting diode (LED). When the input 2150 is the touch panel, the input 2150 and the first display 2130 functionally have a cross-layer structure, which may be regarded as a touch screen.

Referring to FIG. 2, the first storage 2140 of the master output unit 2100 stores the video data transmitted from the video capturing unit 1000. When the first storage 2140 stores the video data, the first storage 2140 synchronizes the video data with the audio data, and thus the video data and the audio data can be selectively stored by a user. When the video data and the audio data are stored, a point at which the storage of the video and audio data starts and a point at which the storage of the video and audio data comes to an end may be designated. To this end, the input 2150 may have a storage button (not shown) for carrying out a storage function.

Referring to FIG. 2, the slave output unit 2200 includes a third communication part 2210, a second decoder 2220, a second display 2230, and a second storage 2240. According to circumstances, the slave output unit 2200 may remove a function of controlling the video capturing unit 1000, and the second display 2230 may receive and output the video data from the video capturing unit 1000.

Further, the slave output unit 2200 including the second display 2230 may include a digital zoom function capable of outputting the video according to a preset magnification and a color change function. The digital zoom function refers to a function by which a magnification of the video to be output can be adjusted by a user. The digital zoom of the video output unit 2000 may be set by the user. The color change function refers to a function of converting a color into a pseudo color and outputting the converted pseudo color. Since recognizable colors are different according to users, the slave output unit 2200 changes an original color into a color which the visually impaired user can easily recognize, and outputs the changed color. For example, when the video output from the video capturing unit 1000 has white letters on a black ground, and the user using the slave output unit 2200 prefers black letters on a white ground, the color can be changed by the slave output unit 2200.

Referring to FIG. 2, the third communication part 2210 of the slave output unit 2200 receives the video data from the first communication part 1500 over the wireless communication network. For short distance wireless communication, a Wi-Fi wireless communication module is preferably used. The second display 2230 outputs the video data received from the first communication part 1500. The second display 2230 is a device capable of outputting video, and may employ an LED, an LCD, or a touch screen like the first display 2130.

The video providing system of the present invention is realized into various embodiments in which the video providing system can be used in private when a user reads a book or a brochure, or be shared when a professor gives a lecture to students.

Hereinafter, when the video capturing unit 1000 and the master output unit 2100 controlling the video capturing unit 1000 performs communication on a 1:1 basis (embodiments 1 and 2), and when the video capturing unit 1000 communicates with the master output unit 2100 and the multiple slave output units 2200 (embodiments 3 and 4) will be described separately. Meanwhile, in embodiment 5, description will be made of operation mechanisms of the first and second driving means of the video capturing unit 1000 in consideration of individual use and group use for giving a lecture, for instance, when the master output unit alone or both of the master output unit and the slave output unit are used.

[Embodiment 1] 1:1 communication between video capturing unit 1000 and video output unit 2000 (open mode)

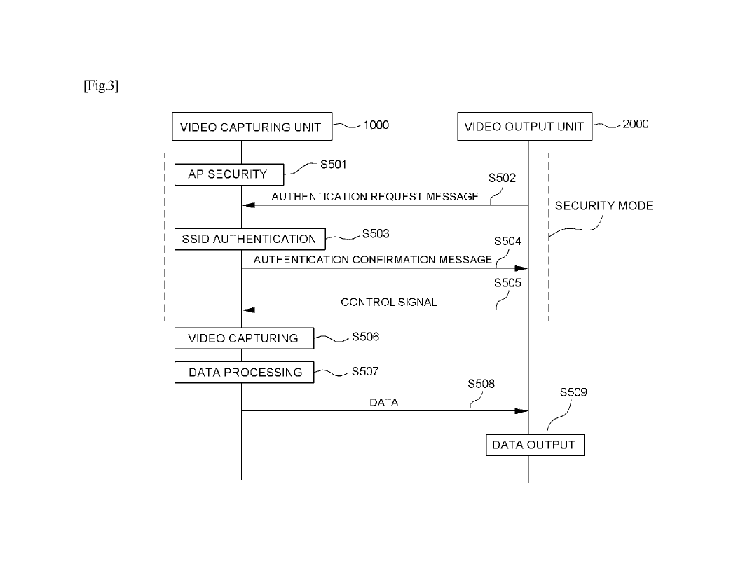

This proceeds without a security mode process of FIG. 3.

Referring to FIG. 3, as a user inputs an instruction, the video capturing unit 1000 captures video of a subject in response to a transmitted control signal (S506). When the capturing is completed, the captured video is processed or compressed in a predetermined data format by the encoder 1300 (see FIG. 2) (S507). The video to be transmitted is compressed into optimized video data. Thereby, it is possible to obtain an effect of reducing the amount of data and an effect of increasing the wireless transceiving speed due to the reduced amount of data. Here, the data may include video data and audio data. The video capturing unit 1000 transmits the compressed video data to the video output unit 2000 over a wireless communication network (S508). The video output unit 2000 outputs the data transmitted via the first decoder 2120 (see FIG. 2) (S509). Here, since the video output unit 2000 can preferably control the video capturing unit 1000, the master output unit 2100 is preferably used.

[Embodiment 2] 1:1 communication between video capturing unit 1000 and video output unit 2000 (security mode)

This proceeds with the security mode of FIG. 3 added.

Referring to FIG. 3, the first communication part 1500 of the video capturing unit 1000 sets an access point (AP) mode to a security mode (S501). Generally, AP refers to a wireless sharer, and the AP mode refers to a wireless sharer mode. To set the AP mode to the security mode, an encryption scheme such as wired equivalent privacy (WEP), RADIUS, Wi-Fi protected access (WPA) is used. As an example of the encryption scheme, WEP security is an encryption scheme of converting an encoded character string into hexadecimal and generating an encryption key. If the character string to be encoded is designated as a “password,” the designated “password” is converted into the hexadecimal, and the encryption key is generated as “4E006F405F.” Thus, to provide access to the video capturing unit 1000, the encryption key generated as “4E006F405F” should be input. Here, the character string to be used for encryption can be arbitrarily set by a user, and the encryption key is automatically generated as the hexadecimal.

When the security setting of the AP is completed, the video output unit 2000 transmits an authentication request message to the video capturing unit 1000 (S502). Here, the authentication request message is a request message for receiving authority capable of accessing and controlling the video capturing unit 1000. The video capturing unit 1000 responds to the authentication request message transmitted from the video output unit 2000 and executes service set identifier (SSID) authentication (S503). SSID is an inherent identifier that is added to a header of each of packets transmitted through a wireless local area network (LAN), has a length of 32 bytes, and is used as encryption when wireless devices provide access to a basic service set (BSS). SSID distinguishes one wireless LAN from other wireless LANs, and all of the APs or wireless devices intended to access a specific wireless LAN always have to use the same SSID. In other words, SSID is a name displayed when searching for the video capturing unit 1000. Thus, only when the SSID authentication providing for the video capturing unit 1000 is completed, the video output unit 2000 can provide access to the video capturing unit 1000 by radio. The master output unit 2100 performs the SSID authentication by inputting the encryption key generated in the previous process S501.

When the SSID authentication is completed, the video capturing unit 1000 transmits an authentication confirmation message to the video output unit 2000 (S504). When the encryption key given to the SSID is accurately input, the video capturing unit 1000 transmits a notification message notifying that access has been provided to the video output unit 2000. Thus, the master output unit 2100 can provide access to the video capturing unit 1000. In contrast, when the encryption key given to the SSID is inaccurately input, the video capturing unit 1000 transmits a notification message notifying that access has not been provided to the video output unit 2000. Thus, the video output unit 2000 receives a notification message notifying that the encryption key should be input again.

When the confirmation of the authentication is completed, the video output unit 2000 transmits a control signal for controlling the video capturing unit 1000 (S505). A video capturing process (S506), a data processing process (S507), a data transmitting process (S508), and a data outputting process (S509) are as described above. Meanwhile, as described above, the video output unit 2000 preferably uses the master output unit 2100.

[Embodiment 3] 1:N communication between video capturing unit 1000 and video output unit 2000 (AP security mode)

Technical features overlapping with the above embodiments 1 and 2 will not be described or will be described in brief. Embodiment 3 will be described below with reference to FIGS. 2, 4 and 5.

Embodiment 3 is preferably used for a professor and students when the professor gives a lecture.

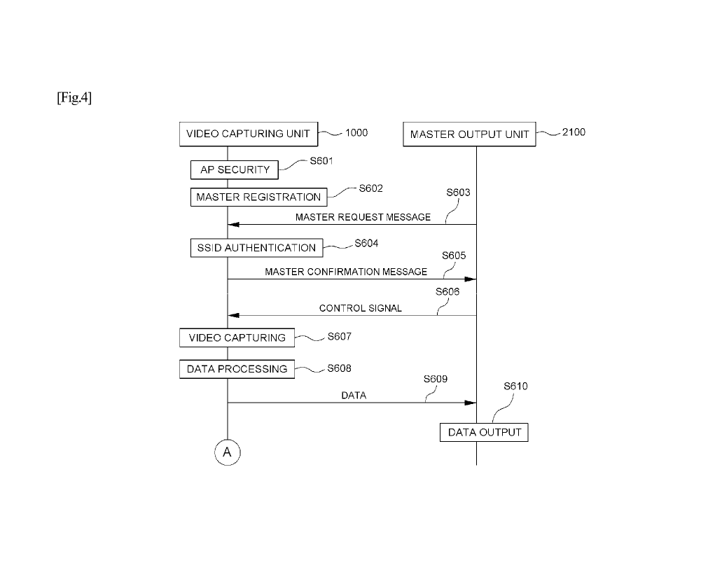

Referring to FIGS. 2 and 4, the first communication part 1500 of the video capturing unit 1000 sets an AP mode to a security mode (S601). The first communication part 1500 generates an encryption key capable of providing access to the video capturing unit 1000. The master output unit 2100 is registered with the video capturing unit 1000 so as to be able to control the video capturing unit 1000 (S602). The master output unit 2100 transmits a master authentication request message to the video capturing unit 1000 (S603). Here, the master authentication request message refers to a request message for checking whether not it is identical to the master output unit 2100 registered in process S602. The video capturing unit 1000 executes master authentication in response to the master authentication request message (S604). The master authentication may be executed using a password set for a user when the master output unit 2100 is registered in process S602, and is automatically executed when the registered master output unit 2100 transmits the master authentication request message to the video capturing unit 1000. Here, the master authentication is not limited to the above example. When the master authentication is completed, the video capturing unit 1000 transmits a master confirmation message to the master output unit 2100 (S605). When the generated encryption key is accurately input during the master registration or when the registered master output unit makes a request for a master, a notification message notifying that access has been provided to the video capturing unit 1000 is transmitted, and the master output unit 2100 can access and control the video capturing unit 1000.

The master output unit 2100 transmits a control signal for controlling the video capturing unit 1000 to the video capturing unit 1000 (S606). The video capturing unit 1000 captures video of a subject according to the transmitted control signal (S607). When the capturing is completed, the captured video is compressed in a predetermined data format (S608). The video capturing unit 1000 transmits the compressed video data to the master output unit 2100 over a wireless communication network (S609). The master output unit 2100 outputs the transmitted video data (S610).

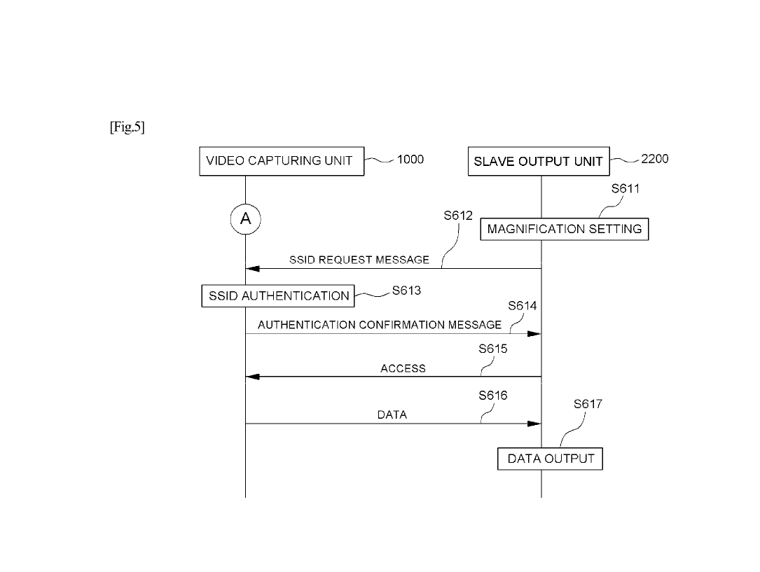

Referring to FIGS. 2 and 5, the slave output unit 2200 sets the output magnification of the data (S611). The slave output unit 2200 transmits an SSID authentication request message to the video capturing unit 1000 (S612). The video capturing unit 1000 executes SSID authentication in response to the SSID authentication request message transmitted from the slave output unit 2200 (S613). Here, the SSID authenticating process is a process for providing access to the video capturing unit 1000 to receive video. When the SSID authentication is completed, the video capturing unit 1000 transmits an authentication confirmation message to the slave output unit 2200 (S614). When the encryption key given to the SSID is accurately input, the video capturing unit 1000 transmits a notification message notifying that access has been provided to the slave output unit 2200. When the SSID authentication is completed, the slave output unit 2200 provides access to the first communication part 1500 (S615). The video capturing unit 1000 transmits the compressed video data to the slave output unit 2200 over a wireless communication network (S616). The slave output unit 2200 outputs the transmitted video data (S617).

[Embodiment 4] 1:N communication between video capturing unit 1000 and video output unit 2000 (AP open mode)

Technical features overlapping with embodiment 1 will not be described or will be described in brief. Embodiment 4 will be described below with reference to FIGS. 2, 6 and 7.

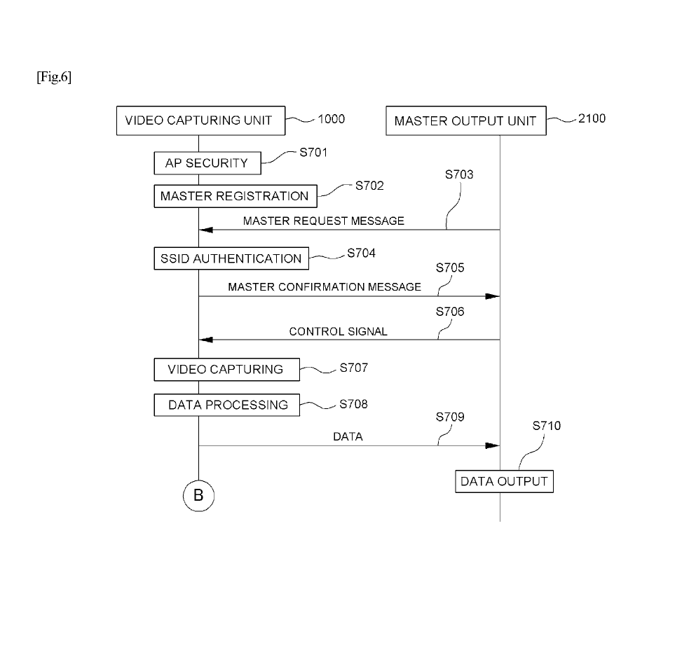

Referring to FIGS. 2 and 6, the first communication part 1500 of the video capturing unit 1000 sets an AP mode to an open mode (S701). Since the AP mode is set to the open mode, the first communication part 1500 generates no encryption key. The video capturing unit 1000 registers the master output unit 2100 capable of controlling the video capturing unit 1000 (S702). The master output unit 2100 transmits a master authentication request message to the video capturing unit 1000 (S703). The video capturing unit 1000 executes master authentication in response to the master authentication request message (S704).

When the master authentication is completed, the video capturing unit 1000 transmits a master confirmation message to the master output unit 2100 (S705). When the generated encryption key is accurately input during the master registration or when the registered master output unit makes a request for a master, a notification message notifying that access has been provided to the video capturing unit 1000 is transmitted, and the master output unit 2100 can access and control the video capturing unit 1000.

When the master output unit 2100 transmits a control signal for controlling the video capturing unit 1000 (S706), the video capturing unit 1000 captures video of a subject according to the transmitted control signal (S707). When the capturing is completed, the captured video is compressed in a predetermined data format (S708). The video capturing unit 1000 transmits the compressed video data to the master output unit 2100 over a wireless communication network (S709). The master output unit 2100 outputs the transmitted video data (S710).

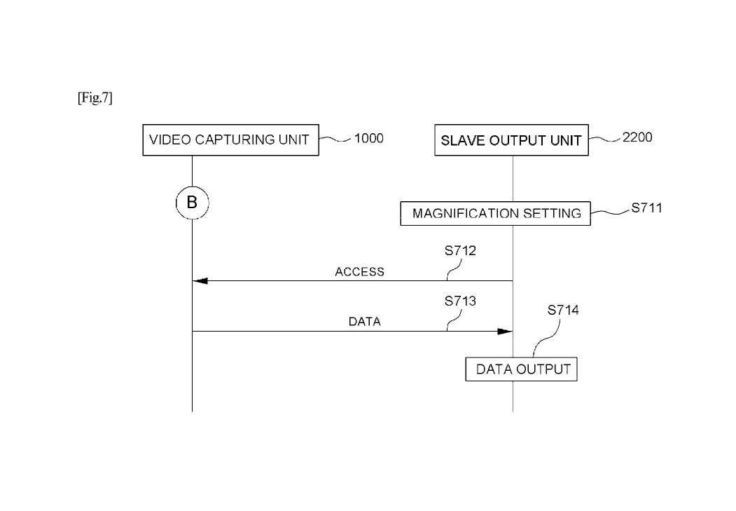

Referring to FIGS. 2 and 7, the slave output unit 2200 sets the output magnification of the data (S711). The slave output unit 2200 receives only the captured video from the video capturing unit 1000. Meanwhile, the colors and sizes of favorite characters may differ according to users. The color change and the magnification adjustment can be adjusted according to the user by the slave output unit 2200. The color change is converted in a pseudo color structure by the slave output unit 2200. The slave output unit 2200 receives and outputs only the video captured simply, and outputs the data with a magnification set by the user using a digital zoom function. The slave output unit 2200 provides access to the first communication part 1500 (S712). The video capturing unit 1000 transmits the compressed video data to the slave output unit 2200 over a wireless communication network (S717). The slave output unit 2200 outputs the transmitted video data (S713).

### [Embodiment 5]

In the present invention, in the case of individual use or group use when a lecture is given, a subject can be captured to increase usefulness according to a position at which the subject is placed. To this end, the driving means 1200 of the video capturing unit 1000 will be described.

The driving means 1200 of the present invention may include at least one of a first driving means 1210 and a second driving means 1220.

Referring to FIGS. 1 and 8, the first driving means 1210 is provided to allow the capturing means 1100 to be rotated in a first direction (see FIG. 1) or around an X axis (see FIG. 8), and the second driving means 1220 is provided to allow the video capturing means 1100 to be rotated in a second direction (see FIG. 1) or a Y axis (see FIG. 8).

Referring to FIG. 8, the first driving means 1210 connects the support 1600 and the video capturing means 1100. The first driving means 1210 is provided with a first motor 1211 that is rotatably engaged with a gear 1601 installed on the support 1600. In detail, a gear 1212 of the first motor 1211 is engaged with the gear 1601, and is rotated to allow the video capturing means 1100 to be rotated around the X axis.

Referring to FIG. 8, the second driving means 1220 includes a connecting rod 1221 connecting the first driving means 1210 and the video capturing means 1100, a gear 1222 formed on an outer circumferential surface of the connecting rod 1221, and a second motor 1223 engaged with the gear 1222 so as to allow the video capturing means 1100 to be rotated around the Y axis.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A system for providing video for a visually impaired person comprising:
an video capturing unit configured to capture video of a subject; and
a master output unit configured to control the video capturing unit and to display the video captured by the video capturing unit,
wherein the video capturing unit includes:
a video capturing means configured to have at least one camera device for capturing the video of the subject;
an encoder configured to compress the video in a predetermined data format;
a first communication part configured to transmit the compressed video data to the master output unit over a wireless communication network; and
a controller configured to control the video capturing means, the encoder, and the first communication part, and
the master output unit includes:
an input configured to input a control signal for controlling the video capturing unit;
a second communication part configured to transmit the input control signal to the video capturing unit over the wireless communication network and to receive the processed video data from the video capturing unit;
a first decoder configured to decode the video data received from the video capturing unit;
a first display configured to output the decoded video data; and
a storage configured to store the received data.

2. The system according to claim 1, wherein the first communication part includes a function as a wireless sharer, is set to a security mode, and transmits the data to the master output unit that is granted access to the video capturing unit.

3. The system according to claim 1, further comprising a slave output unit having a third communication part receiving the processed video data from the video capturing unit, a second decoder decoding the video data received from the video capturing unit, and a second display outputting the decoded video data.

4. The system according to claim 1, wherein the video capturing unit further includes a driving means for rotating the video capturing means.

5. The system according to claim 1, wherein:
the video capturing unit further includes a microphone receiving audio data from outside; and
the storage synchronizes the video data and the audio data and stores the synchronized data.
